(19) United States
(12) Patent Application Publication
(10) Pub. No.: US 2006/0256078 A1
(43) Pub. Date: Nov. 16, 2006

(54) INFORMATION NAVIGATION PARADIGM FOR MOBILE PHONES

(75) Inventors: Ed Flinchem, Seattle, WA (US); Brent Van Wieringen, Seattle, WA (US)

Correspondence Address: BLACK LOWE & GRAHAM, PLLC, 701 FIFTH AVENUE, SUITE 4800, SEATTLE, WA, 98104, US

(73) Assignee: MELODEO INC., Seattle, WA (US)

(21) Appl. No.: 11/306,032

(22) Filed: Dec. 14, 2005

Related U.S. Application Data
(60) Provisional application No. 60/636,335, filed on Dec. 14, 2004.

(51) Int. Cl. G09G 5/00

(52) U.S. Cl. 345/156

(57) ABSTRACT

In a mobile phone, methods and systems for rapidly and efficiently navigating through and browsing large structures of related information. An interface of one or more states presenting user selectable items, such that any item may be activated in one or more ways to directly access multiple levels of an underlying catalog or other structured arrangement of information.

### CROSS-REFERENCE TO RELATED APPLICATIONS

This application claims the benefit of U.S. Provisional Application Ser. No. 60/636,335, filed Dec. 14, 2004. The contents of which are hereby incorporated by reference

### BACKGROUND OF THE INVENTION

Mobile phones are typically equipped with always on or on demand access to wireless data networks, through which it is possible to access ever larger databases of information stored in remote locations. The challenge to the user is to effectively and rapidly navigate such data on a device typically limited to a small screen and to a keypad with many fewer keys than a desktop (QWERTY) keyboard and no mouse or other high resolution navigation input.

The standard solution is to access information though a browser metaphor (WAP) presenting one screen of information at a time with links to other pages retrieved one at a time from remote locations.

Therefore, there exists a need for a more user friendly interface for small screen devices such as on a mobile phone or comparable device.

### BRIEF SUMMARY OF THE INVENTION

For situations where data are structured in common ways, such as hierarchies of information (e.g. music (see 200), phonebooks (state, city, category, name), news or other serial publications (publication, headlines, topics, volume number or date)), the present invention includes systems and methods that enable rapid, easy, and intuitive navigation though locally stored information within the mobile phone. The local information may be first received, in whole or as a series of updates, from a remote server.

### BRIEF DESCRIPTION OF THE SEVERAL VIEWS OF THE DRAWING

The preferred and alternative embodiments of the present invention are described in detail below with reference to the following drawings.

FIGS. 1-5 are images of a user interface for a mobile device formed in accordance with an embodiment of the present invention; and

FIG. 6 is a schematic diagram of data used by the user interfaces of FIGS. 1-5.

### DETAILED DESCRIPTION OF THE INVENTION

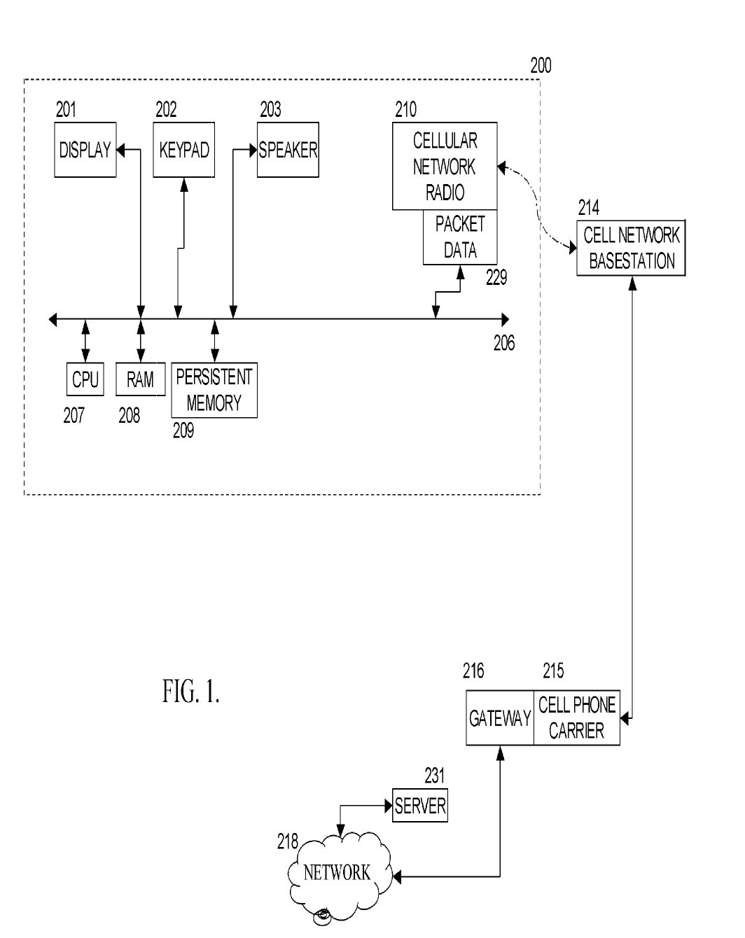

FIG. 1 illustrates a mobile phone 200. The phone 200 includes a screen 201 and speaker(s) 203. Messages are presented one the screen 201 and through the speaker(s) 203. The screen 201 is also used by a user for selection of recipients. A data bus 206 is connected to various elements of the phone 200. The phone 200 also includes a processor 207, random access memory (RAM) 208 and persistent memory 209, which could be re-writeable FLASH memory. The phone 200 includes a radio 210 to communicate with cellular wireless voice and data network base stations 214 through their associated mobile phone carrier 215 and onward through a gateway 216 to a public or private data network 218, such as the Internet.

The radio 210 can send and receive a variety of packet data 229 using one of a variety of protocols (UDP, TCP, SMTP, HTTP, etc) through the data network 218. Connected to the data network 218 is a server complex 231. The server complex 231 stores and can send structured catalog data to the phone 200.

The phone 200 executes a catalog access user interface application that allows a user to easily traverse through a multi-level catalog of various topics. The multi-level catalog may be stored with the memory 209 or may be retrieved from other sources, such as the server 231, over the network 218.

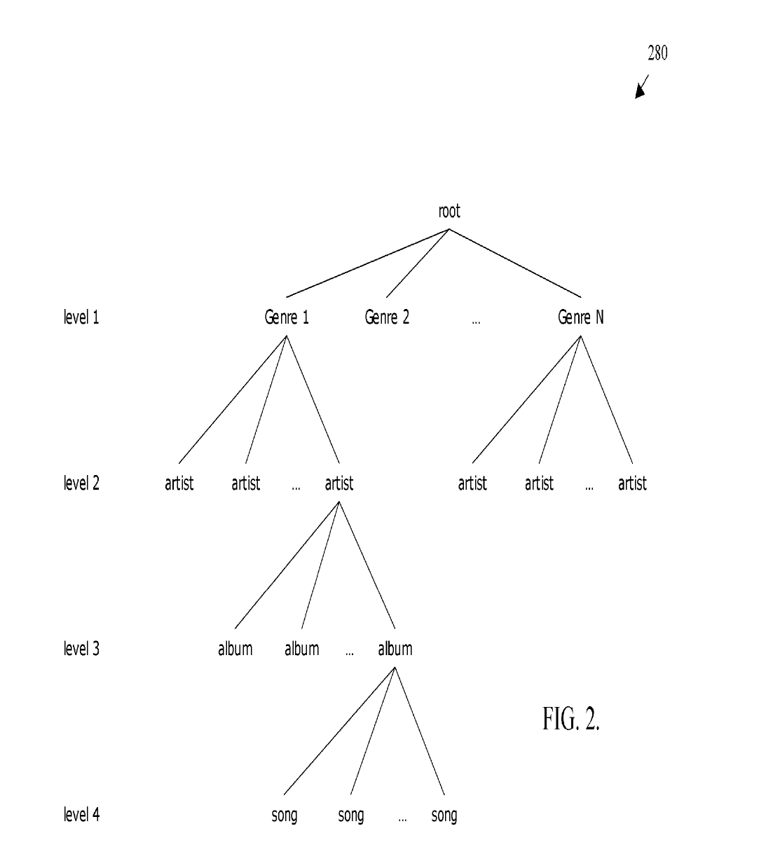

FIG. 2 illustrates a tree structure 280 of an example catalog that is accessible by a user operating the phone 200 shown in FIG. 1. In one embodiment, the tree structure 280 includes 4 levels. This example catalog is a catalog of music, which is the root. Level 1 includes various Genres of music. Level 2 includes specific artists that may be associated with one or more Genres from Level 1. Level 3 includes albums or compilations of songs that that may be associated with one or more artists from Level 2. Level 4 includes songs that that may be associated with one or more albums from Level 3.

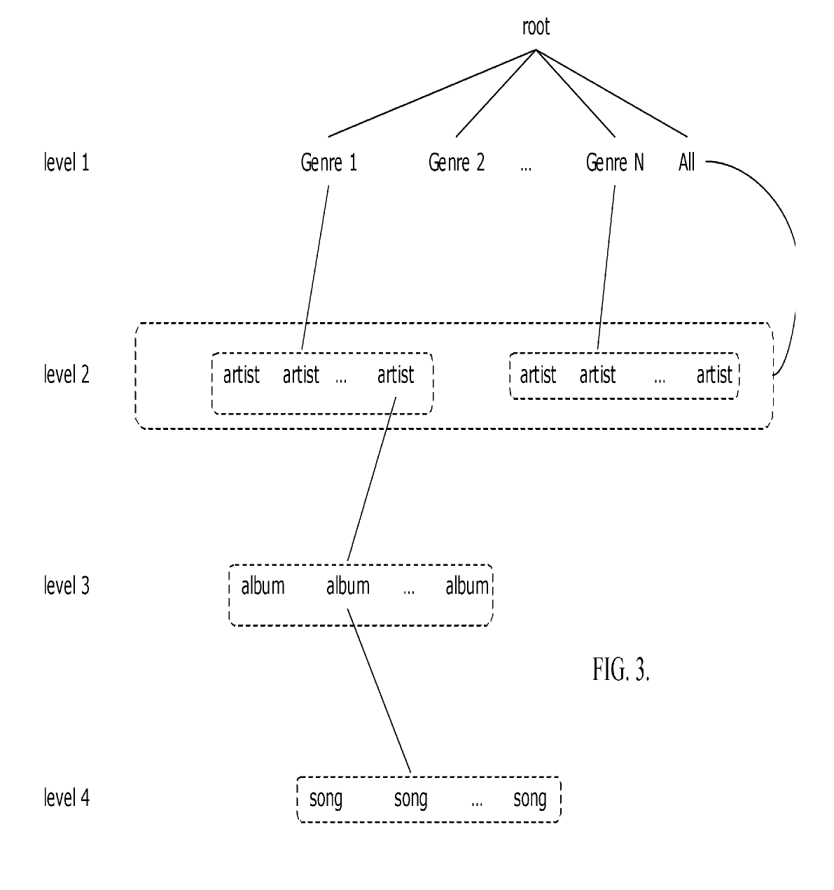

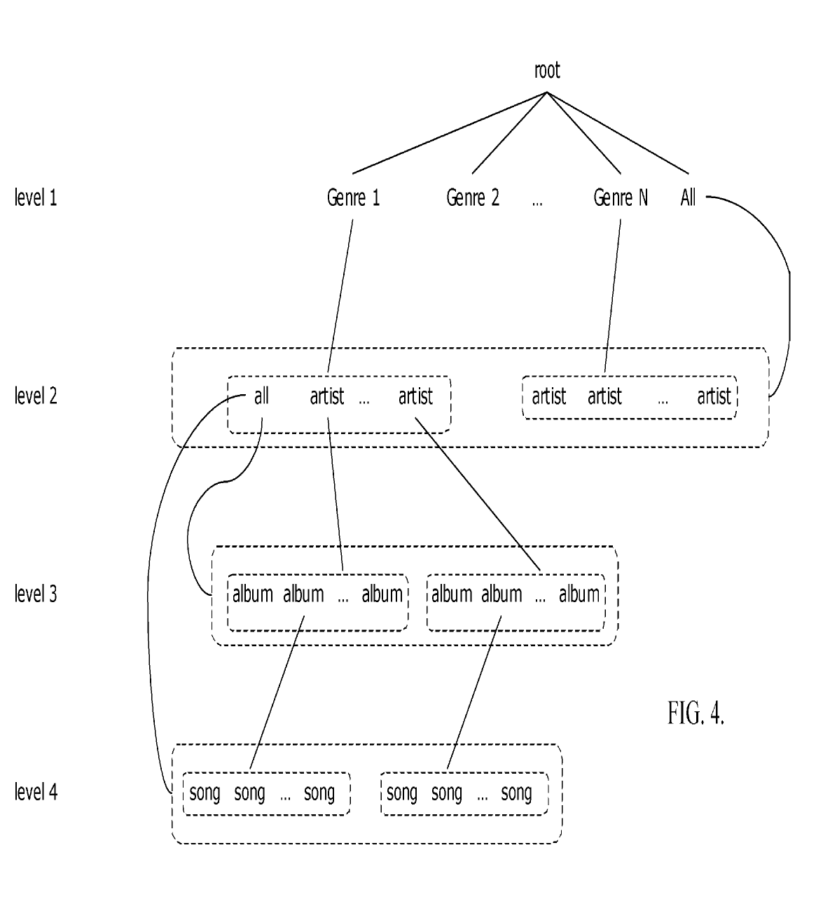

FIGS. 3-5 illustrate an All selection that can be included in any Level except the last level—Level 4. Normally when one traverses down the tree structure 280, the information from the catalog that is presented to the user is the sub information of the item selected from the above Level. For example, if the user selects Genre 1, the user is presented with all the artists (Level 2) of Genre 1. However, if the user selected All in Level 1, all artists across all Genres are presented to the user. Referring to FIG. 4, if the user selected all from Level 2 when in the artists of Genre 1, then all the albums of all the artists of Genre 1 are presented.

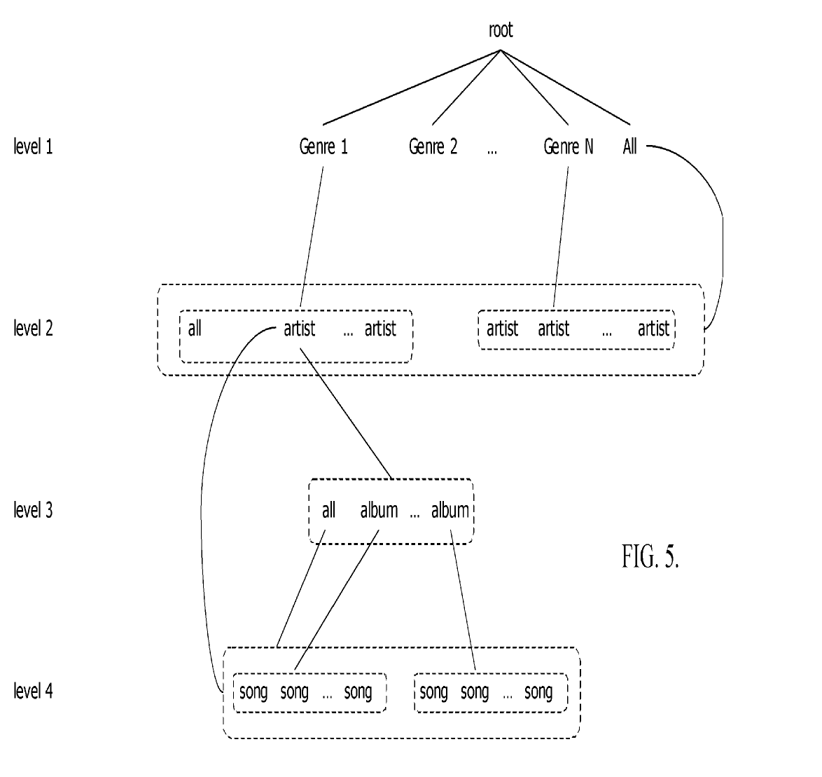

As shown in FIGS. 4 and 5, the user can traverse from Level 2 to Level 4 by selecting an artist or all in Level 2 and selecting a song option. This is shown by example in FIGS. 8-10.

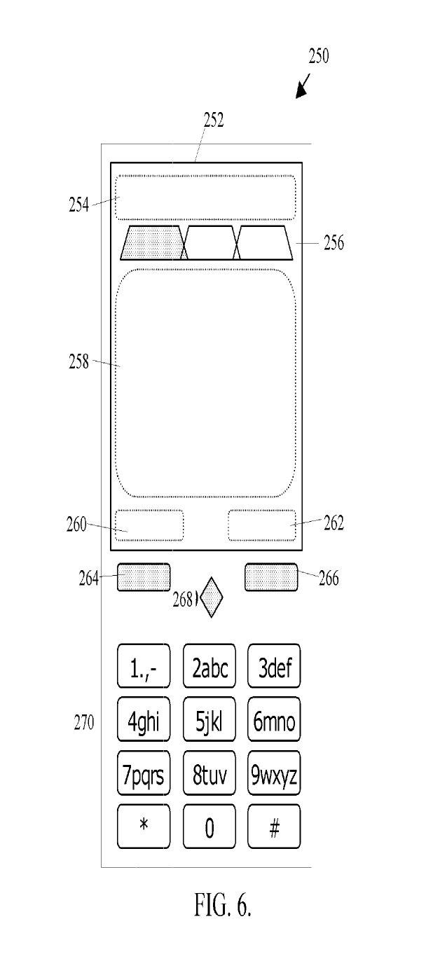

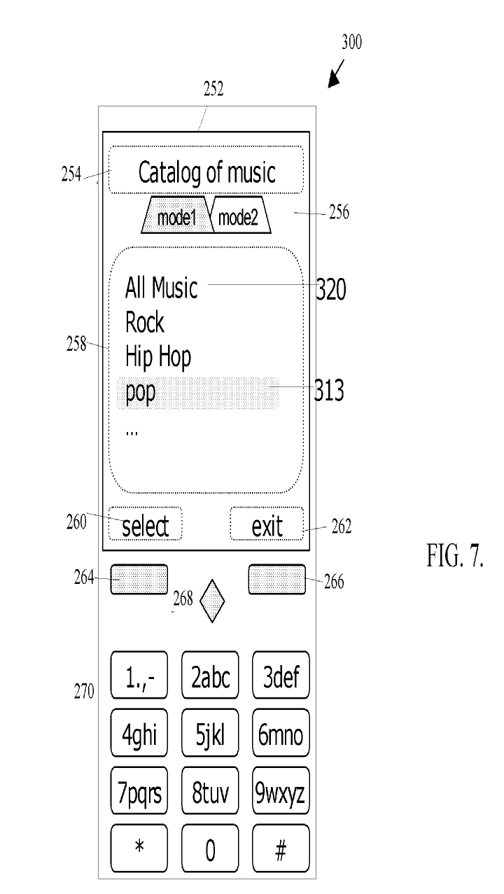

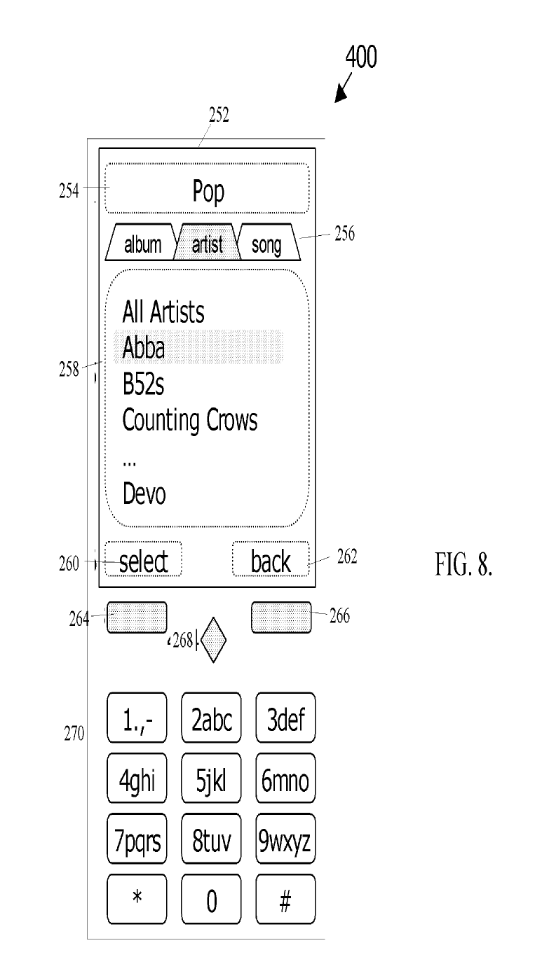

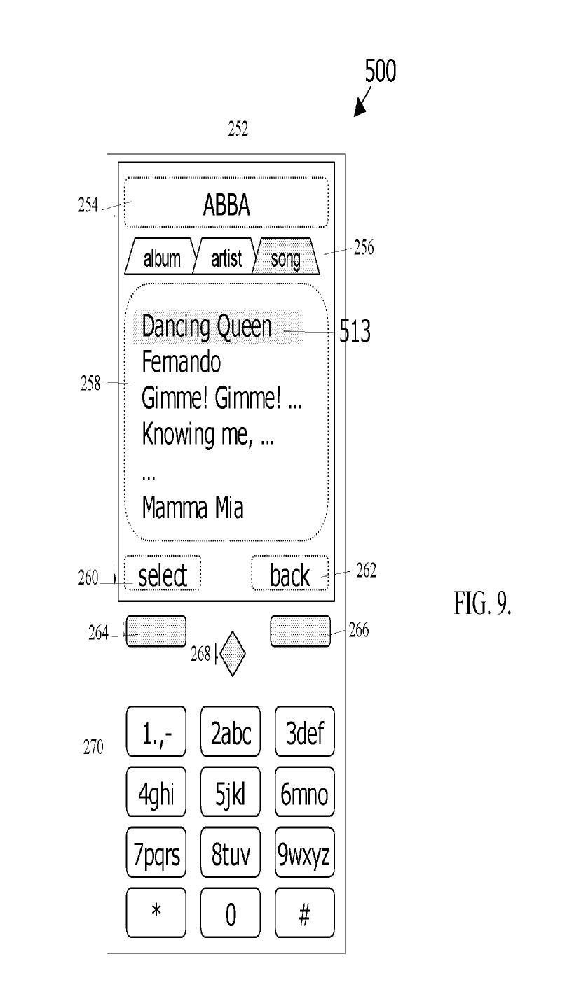

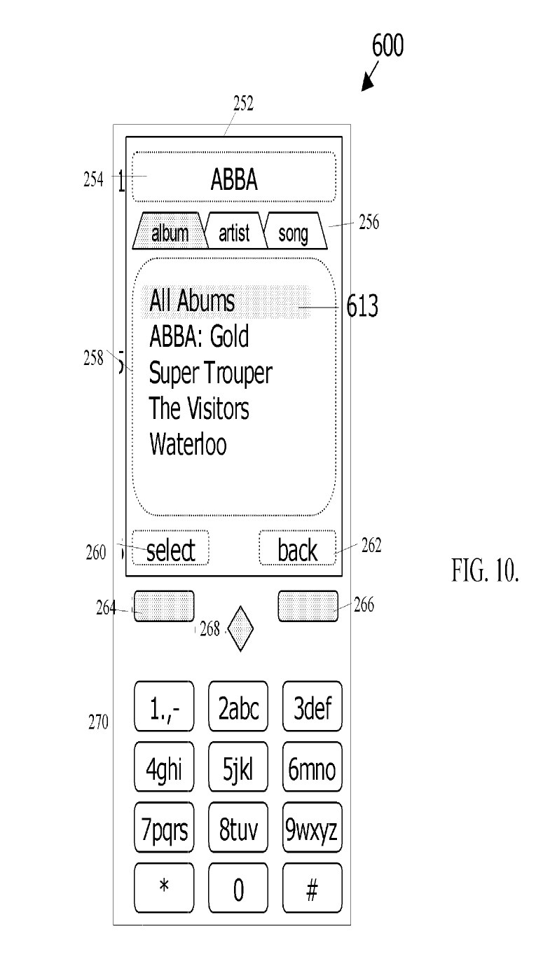

FIG. 6 shows a front view of a mobile device 250, such as a mobile phone. The device 250 includes a screen 252 for displaying information. A first area 254 of the screen 252 displays a main title or header. A second area 256 of the screen 252 displays optional subsidiary header information. A third area 258 of the screen 252 displays a list associated with whatever is presented in the first area 254. A fourth area 260 of the screen 252 displays a label over a left key 264 and a fifth area 262 of the screen 252 displays a label over a right key 266.

The device 250 includes a 5-way switch or joystick (up, down, left, right, and press) 268 or other combination of switches having at least four inputs. Optionally included is a 12 key pad 270, such as a phone dialing pad.

As shown by example in FIG. 7, a title (e.g., Category of music) is displayed in first area 254 on the screen 252 when the user opens a catalog user interface application. If the application has more than one mode, the active mode is indicated by a highlighted tab in the second area 256. The joystick 268 allows a user to navigate between modes. In mode 1, a list or partial list of top level categories or genres is displayed in the third area 258. One of the categories or genres in the list is highlighted (pop 313). The list includes a category/genre selectable indicator 320, which conveys the meaning of the items presented below it. The indicator 320 is comparable to all as shown in FIGS. 3-5.

In one embodiment, if a user exits the displayed application, by activation of the right key 266 to select exit that is located in the fifth area 262, and returns to the application at a later time, the highlighted category/item at the moment of exit is remembered and restored.

When the user moves the joystick 268 up or down, a different item in the list is highlighted. If the user then depresses the joystick 268 or activates the left key 264 that is under the term select in the fourth area 260, the application transitions the interface to a next state, which is a navigation to the relevant set or subset of the catalog data. For example, after the user has depressed the joystick 268 or activated the left key 264 when pop 313 was highlighted, the user interface 400 shown FIG. 4 is presented. The title is changed to Pop (first area 254) and the items having a child relationship to Pop are displayed in the second and third areas.

In another embodiment, the underlying data to be browsed or navigated may have any number of levels.

The user interface 400 includes rapid access to multiple levels of information in the underlying catalog. In this example three levels as shown in the second area 256. The left/right joystick 268 allows one to navigate between the levels shown in the second area 256.

Upon entry into the user interface 400 from the user interface 300, catalog information from the subset of the first level of the catalog selected by the user in user interface 300 is displayed.

In one embodiment, the relatively highest accessible level is centered in the second area 256 and other levels are positioned on either side of that. The other levels in the second area 256 are each accessible by a left or right motion of the joystick 268. Other arrangements of levels are possible as are other arrangements of keys to cause the transition.

A top item displayed in the third area 258 identifies the meaning of all other items listed below it. For example, “All Artists” is the general description associated with the “artist” tab in the second area 256 for describing the list of items presented below “All Artists”.

When the user moves the joystick 268 to the right or activates the key 264 located below “select”—the fifth area 260, the user interface transitions to the fourth level user interface 500, FIG. 9. In this example, “Abba” was highlighted before the transition. Therefore, the user interface 500 presents “song” category information previously stored and associated with “Abba”.

When the user moves the joystick 268 to the left, the user interface transitions to the third level user interface 600, FIG. 10. In this example, because “Abba” was highlighted before the transition, the “album” information previously associated with “Abba” is presented in the second area 258. Other arrangements of the levels 3 and 4 are possible. One item 613 of the third level (or any level above the terminal level) conveys the meaning of all things at this level—“All Albums”.

Up/down actions of the joystick 268 changes which item in the second area 258 is selected/highlighted.

Activation of right key 266 when “back” is located in the fifth area 262 transitions the interface back to the previous interface at which point the highlighted item in the second area 258 is the item associated with the title that was displayed in the first area 254. For example, when the user selects the right key 266 in user interface 400 with “Pop” in the title/first area 254, the user interface 300 appears with “pop” highlighted in the second area 258. In other words, the title in the title/first area 254 optionally displays the name of the higher level category from which the user navigated to enter this user interface. This may be one or more levels above in the underlying catalog—information presently displayed in the second area 258.

When in the user interface 500, an inward press of the joystick 268 or activation of the key 264 transitions the interface to take actions associated with the indicated/highlighted catalog item in the second area 258. For example, an action may include purchase, download, content render (playback), present more information associated with the item, or other actions depending on the selection for input or an initial state.

When a left motion of the joystick 268 is performed, the user interface 500 is transitioned to the second level of the catalog information, user interface 400, at which point the highlight appears on the line which was last selected in the navigational sequence at the most recent instance when level two of the catalog was visible (or the highest accessible catalog level from the current state).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A system for navigation thru a previously defined hierarchical data structure, the system comprising:
a display;
memory configured to store the previously defined hierarchical data structure, wherein the hierarchical data structure includes at least three levels;
a user interface device; and
a processor in data communication with the display, the memory, and the user interface device, the processor comprising:
a graphical user interface component configured to generate a graphical user interface for display on the display; and
a navigation component configured to allow a user to navigate between the levels based upon user operation of the user interface device,
wherein motion of the user interface device along a first axis causes the navigation component to change a presently selected first sub level item, a first directional motion of the user interface device along a second axis causes the navigation component to change the user interface to display one or more items in the hierarchical data structure that are one level removed from the previously selected first sub level item, and a second directional motion of the user interface device along the second axis causes the navigation component to change the user interface to display one or more items in the hierarchical data structure that are two levels removed from the previously selected first sub level item.

2. The system of claim 1, wherein the user interface device comprises:
a first key that when activated by a user causes the navigation component to change the graphical user interface to display the data in the hierarchical data structure that is associated with a selected item; and
a back key that when activated by a user causes the navigation component to change the user interface to display the data in the hierarchical data structure that is a level above the selected item.

3. The system of claim 1, wherein the navigation component allows a user to view all items in any of the levels.

4. The system of claim 1, wherein the navigation component allows a user to view all items in a level that are associated with a selected item removed by 2 levels.

5. The system of claim 1, wherein the hierarchical data structure includes a catalog of music having a first level that includes genres of music, a second level that includes artists; a third level that includes albums, and a fourth level that includes songs.

6. The system of claim 5, wherein the first directional motion of the user interface device along the second axis causes the navigation component to change the user interface to display albums of a selected artist and wherein the second directional motion of the user interface device along the second axis causes the navigation component to change the user interface to display songs associated with the selected artist.

7. The system of claim 6, wherein the first directional motion of the user interface device along the second axis causes the navigation component to change the user interface to display all albums of a selected genre of music and wherein the second directional motion of the user interface device along the second axis causes the navigation component to change the user interface to display all songs associated with at least one of the selected artist or the selected genre of music.

8. The system of claim 1, wherein the system is a mobile phone.

9. The system of claim 1, wherein at least a portion of the hierarchical data structure is stored at a remote server and the processor includes a component for dynamically retrieving at least one portion of the hierarchical data structure stored on a remote server based on user interaction.

10. A method for navigation thru a previously defined hierarchical data structure, the method comprising:
a) storing the previously defined hierarchical data structure, wherein the hierarchical data structure includes at least three levels;
b) allowing a user to navigate between the levels based upon user operation of a user interface device,
c) changing a presently selected first sub level item if a first motion of the user interface device along a first axis has been sensed;
d) changing the user interface to display one or more items in the hierarchical data structure that are one level removed from the previously selected first sub level item, if a first directional motion of the user interface device along a second axis has been sensed; and
e) changing the user interface to display one or more items in the hierarchical data structure that are two levels removed from the previously selected first sub level item, if a second directional motion of the user interface device along the second axis has been sensed.

11. The method of claim 10, further comprising:
changing the graphical user interface to display the data in the hierarchical data structure that is associated with a selected item, when a first key activated by a user; and
changing the user interface to display the data in the hierarchical data structure that is a level above the selected item, when a back key is activated by a user.

12. The method of claim 10, further comprising allowing a user to view all items in any of the levels.

13. The method of claim 10, further comprising allowing a user to view all items in a level that are associated with a selected item removed by 2 levels.

14. The method of claim 10, wherein the hierarchical data structure includes a catalog of music having a first level that includes genres of music, a second level that includes artists; a third level that includes albums, and a fourth level that includes songs.

15. The method of claim 14, further comprising:
changing the user interface to display albums of a selected artist, when the first directional motion of the user interface device along the second axis has been sensed; and
changing the user interface to display songs associated with the selected artist, when the second directional motion of the user interface device along the second axis has been sensed.

16. The method of claim 15, further comprising:
changing the user interface to display all albums of a selected genre of music, when the first directional motion of the user interface device along the second axis has been sensed; and
changing the user interface to display all songs associated with at least one of the selected artist or the selected genre of music, when the second directional motion of the user interface device along the second axis has been sensed.

17. The method of claim 10, wherein a-e are performed on a mobile phone.

18. The method of claim 10, wherein storing comprises storing at least a portion of the hierarchical data structure at a remote server, further comprising:
dynamically retrieving at least one portion of the hierarchical data structure that is stored on a remote server based on user interaction.
